(19) United States
(12) Patent Application Publication
(10) Pub. No.: US 2026/0208408 A1
(43) Pub. Date: Jul. 23, 2026

(54) OVERMOLDED PLASTIC ARTICLES, USES THEREOF, METHOD OF MAKING

(71) Applicant: SOLVAY SPECIALTY POLYMERS USA, LLC, Alpharetta, GA (US)

(72) Inventors: Guy Van Meulebeke, Bruxelles (BE); David Mcllroy, Johns Creek, GA (US); Gilles Divoux, Roswell, GA (US)

(73) Assignee: SOLVAY SPECIALTY POLYMERS USA, LLC, Alpharetta, GA (US)

(21) Appl. No.: 19/138,577

(22) PCT Filed: Nov. 21, 2023
(86) PCT No.: PCT/EP2023/082480

§ 371 Date: Jun. 12, 2025

Related U.S. Application Data
(60) Provisional application No. 63/386,941, filed on Dec. 12, 2022.

(30) Foreign Application Priority Data
Feb. 15, 2023 (EP) 23156796.7

(51) Int. Cl. B29C 45/00; B29C 45/14; B29K 77/00; B29K 81/00; B29K 105/16; B29K 105/20; B29K 509/08; B29L 31/30; B29L 31/34

(52) U.S. Cl. CPC B29C 45/0001; B29C 45/14467; B29K 2077/00; B29K 2081/04; B29K 2105/16; B29K 2105/20; B29K 2509/08; B29L 2031/3002; B29L 2031/3406

(57) ABSTRACT

The present invention relates to metal-plastic assemblies comprising at least one metal insert, said metal insert being overmolded with at least one polymer composition including at least one of a polyamide and a polyarylene sulfide, and a flat glass fiber, which provide long term thermal stability and low loss of mechanical properties over extended time and temperature cycles, and which are particularly advantageous for use in automotive applications, e.g. as busbars in e-mobility/power electronic applications.

### CROSS-REFERENCE TO RELATED APPLICATIONS

This application claims priority to US Provisional application filed on Dec. 12, 2022 with No. 63/386,941 and to EP application filed on Feb. 15, 2023 with No. 23156796.7, the whole content of each of these applications being incorporated herein by reference for all purposes

### TECHNICAL FIELD

The present invention relates to metal-plastic assemblies comprising at least one metal insert, said metal insert being overmolded with at least one polymer composition including at least one of a polyamide and a polyarylene sulfide, and a flat glass fiber. In this regard the invention overmolded articles provide long term thermal stability and low loss of mechanical properties over extended time and temperature cycles, which make the same particularly advantageous for use in automotive applications, e.g. as busbars in e-mobility/power electronic applications.

Additional advantages and other features of the present invention will be set forth in part in the description that follows and in part will become apparent to those having ordinary skill in the art upon examination of the following or may be learned from the practice of the present invention. The advantages of the present invention may be realized and obtained as particularly pointed out in the appended claims. As will be realized, the present invention is capable of other and different embodiments, and its several details are capable of modifications in various obvious respects, all without departing from the present invention. The description is to be regarded as illustrative in nature, and not as restrictive.

### BACKGROUND ART

Techniques that require an insert—typically metal—to be assembled with a plastic are well known in the art, and generally involve melt processing the plastic around the metal insert. Encapsulating the insert with plastic creates a single molded plastic piece that's generally stronger than one created using secondary assembly.

It is generally recognized that the melted plastic surrounding a metal insert will shrink as it cools, producing a “hoop” stress in the plastic. This hoop stress will be a constant stress on the plastic part throughout the life of the product and possibly result in cracking if the stress is not minimized during the production process. Indeed, such residual stress is generally considered as a major cause for poor environmental stress cracking resistance, lower short and long term (creep, fatigue) mechanical behaviour, low performances in case of thermal cycling, all those phenomena being exacerbated when the metal component has sharp edges or a weld line.

Now, while processing and design parameters are to be adjusted for minimizing those phenomena, requirements for providing plastic materials offering better compromise of properties in these metal/plastic inserts assemblies.

### BRIEF DISCLOSURE OF THE INVENTION

The invention pertains to a metal-plastic assembly comprising:
a metal insert, having a surface; and
a plastic component, in contact with at least a part of said surface of said metal insert, wherein the plastic component is made from a polymer composition [composition (C)] comprising:
(A) at least one polymer selected from the group consisting of a polyamide polymer [polymer (PA)] and a poly(arylene sulphide) polymer [polymer (PAS)]; and
(B) flat glass fibers [Fibers (FGF)].

The Applicant has surprisingly found that the metal-plastic assembly of the invention, thanks to the incorporation of the flat glass fibers in the plastic component, possesses improved long term thermal stability and reduced loss of mechanical properties over extended time and temperature cycles, which make the same particularly advantageous for use in automotive applications.

### DISCLOSURE OF THE INVENTION

### The Polymer Composition (C)

The polyamide composition (C), above described, may comprise a polymer (PA), a polymer (PAS) or a mixture thereof. It is nonetheless generally understood that either the polyamide composition (C) will comprise a significant amount of polymer (PA) or a significant amount of polymer (PAS), so as to qualify as a polyamide-based or a poly(arylene sulphide)-based composition. “Significant amount” is hereby meant to imply that the designated polymer is the polymer included in major amount in the said composition (C), among all other possible polymer components (if any further).

The polymer (PA) may be present in the polyamide-based composition (C) in a total amount of greater than 30 wt. %, greater than 35 wt. % by weight, greater than 40 wt. % or greater than 45 wt. %, based on the total weight of the polymer composition (C). The polyamide (PA) may be present in the composition (C) in a total amount of less than 95 wt. %, notably less than 90 wt. %, less than 80 wt. %, less than 70 wt. % or less than 60 wt. %, based on the total weight of the polymer composition (C).

The polymer (PA) may for example be present in the polyamide-based composition (C) in an amount ranging between 35 and 60 wt. %, for example between 40 and 55 wt. %, based on the total weight of the polyamide composition (C).

Similarly, the polymer (PAS) may be present in the poly(arylene sulphide)-based composition (C) in a total amount of greater than 30 wt. %, greater than 35 wt. % by weight, greater than 40 wt. % or greater than 45 wt. %, based on the total weight of the polymer composition (C). The polymer (PAS) may be present in the poly(arylene sulphide)-based composition (C) in a total amount of less than 95 wt. %, notably less than 90 wt. %, less than 80 wt. %, less than 70 wt. % or less than 60 wt. %, based on the total weight of the polymer composition (C).

The polymer (PAS) may for example be present in the poly(arylene sulphide)-based composition (C) in an amount ranging between 35 and 60 wt. %, for example between 40 and 55 wt. %, based on the total weight of the polyamide composition (C).

The polymer composition (C) may also comprise one component selected from the group consisting of reinforcing agents different from flat glass fibers, tougheners, plasticizers, colorants, pigments, antistatic agents, dyes, lubricants, thermal stabilizers, light stabilizers, flame retardants, nucleating agents, crosslinking agents, and antioxidants.

As mentioned, the polymer composition (C) of the present invention may comprise a toughener. A toughener is generally a low glass transition temperature (T_{g}) polymer, with a T_{g} for example below room temperature, below 0° C. or even below −25° C. As a result of its low T_{g}, the toughener are typically elastomeric at room temperature. Tougheners can be functionalized polymer backbones.

The polymer backbone of the toughener can be selected from elastomeric backbones comprising polyethylenes and copolymers thereof, e.g. ethylene-butene; ethylene-octene; polypropylenes and copolymers thereof; polybutenes; polyisoprenes; ethylene-propylene-rubbers (EPR); ethylene-propylene-diene monomer rubbers (EPDM); ethylene-acrylate rubbers; butadiene-acrylonitrile rubbers, ethylene-acrylic acid (EAA), ethylene-vinylacetate (EVA); acrylonitrile-butadiene-styrene rubbers (ABS), block copolymers styrene ethylene butadiene styrene (SEBS); block copolymers styrene butadiene styrene (SBS); core-shell elastomers of methacrylate-butadiene-styrene (MBS) type, or mixture of one or more of the above.

When the toughener is functionalized, the functionalization of the backbone can result from the copolymerization of monomers which include the functionalization or from the grafting of the polymer backbone with a further component.

Specific examples of functionalized tougheners are notably terpolymers of ethylene, acrylic ester and glycidyl methacrylate, copolymers of ethylene and butyl ester acrylate; copolymers of ethylene, butyl ester acrylate and glycidyl methacrylate; ethylene-maleic anhydride copolymers; EPR grafted with maleic anhydride; styrene-maleimide copolymers grafted with maleic anhydride; SEBS copolymers grafted with maleic anhydride; styrene-acrylonitrile copolymers grafted with maleic anhydride; ABS copolymers grafted with maleic anhydride.

The toughener may be present in the polymer composition (C) in a total amount of greater than 1 wt. %, greater than 2 wt. % or greater than 3 wt. %, based on the total weight of the composition (C). The toughener may be present in the composition (C) in a total amount of less than 30 wt. %, less than 20 wt. %, less than 15 wt. % or less than 10 wt. %, based on the total weight of the polymer composition (C).

### The Polyamide or Polymer (PA)

The polyamide or polymer (PA) of the polymer composition (C) comprises recurring units (R_{PA}) derived from polycondensation of a diamine and a diacid of formula (AABB) below, and/or units derived from polycondensation of an aminoacid or lactam, of formula (AB) below:

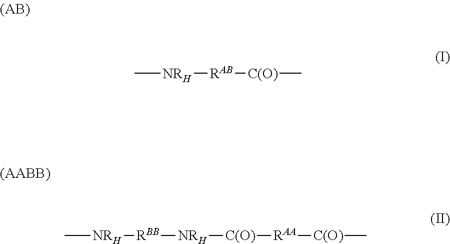

wherein R_{H} is hydrogen or a hydrocarbon group, preferably R_{H} is hydrogen; and R^{AB}, R^{BB}, R^{AA}, equal to or different from each other, are divalent hydrocarbon groups, possibly including one or more than one heteroatom.

The expressions “(co)polyamides” or “polyamides” are hereby used for designating:
homopolyamides containing substantially 100 mol. % of recurring units (R_{PA}) as detailed above
copolyamides comprising at least about 85 mol. % of recurring units (R_{PA}) of formula (I), preferably at least about 90 mol. %, more preferably at least about 95 mol. %, for example at least about 96 mol. %, at least about 97 mol. %, at least about 98 mol. %, at least about 99 mol. %,
with respect to the total moles of recurring units of the said (co)polyamide [polyamide (A)].

Specifically, recurring units (I) and (II) of the polyamide (PA) may be the condensation product of at least one mixture selected from:
mixtures (M1) comprising at least a diacid [acid (DA)](or derivative thereof) and at least a diamine [amine (NN)](or derivatives thereof);
mixtures (M2) comprising at least a lactam [lactam (L)];
mixtures (M3) comprising at least an aminocarboxylic acid [aminoacid (AN)]; and
combinations thereof.

Acid (DA) derivatives include notably salts, anhydride, esters and acid halides, able to form amide groups; similarly, amine (NN) derivatives include notably salts thereof, which are equally able to form amide groups.

Said acid (DA) can be an aromatic dicarboxylic acid comprising two reactive carboxylic acid groups [acid (AR)] or an aliphatic dicarboxylic acid comprising two reactive carboxylic acid groups [acid (AL)]. For the purpose of the present invention, a dicarboxylic acid is considered as “aromatic” when the two reactive carboxylic acid groups are bound to one or more than one aromatic group.

Non limitative examples of acids (AR) are notably phthalic acids, including isophthalic acid (IA), and terephthalic acid (TA), 2,5-pyridinedicarboxylic acid, 2,4-pyridinedicarboxylic acid, 3,5-pyridinedicarboxylic acid, 2,2-bis(4-carboxyphenyl)propane, bis(4-carboxyphenyl)methane, 2,2-bis(4-carboxyphenyl)hexafluoropropane, 2,2-bis(4-carboxyphenyl)ketone, 4,4′-bis(4-carboxyphenyl)sulfone, 2,2-bis(3-carboxyphenyl)propane, bis(3-carboxyphenyl)methane, 2,2-bis(3-carboxyphenyl)hexafluoropropane, 2,2-bis(3-carboxyphenyl)ketone, bis(3-carboxyphenoxy)benzene, naphthalene dicarboxylic acids, including 2,6-naphthalene dicarboxylic acid, 2,7-naphthalene dicarboxylic acid, 1,4-naphthalene dicarboxylic acid, 2,3-naphthalene dicarboxylic acid, 1,8-naphthalene dicarboxylic acid and biphenyl-4,4′-dicarboxylic acid. Acids (AR) which are particularly preferred are IA and TA.

Among acids (AL), mention can be notably made of malonic acid (HOOC—CH₂—COOH), succinic acid [HOOC—(CH₂)₂—COOH], glutaric acid [HOOC—(CH₂)₃—COOH], 2,2-dimethyl-glutaric acid [HOOC—C(CH₃)₂—(CH₂)₂—COOH], adipic acid [HOOC—(CH₂)₄—COOH], 2,4,4-trimethyl-adipic acid [HOOC—CH(CH₃)—CH₂—C(CH₃)₂— CH₂—COOH], pimelic acid [HOOC—(CH₂)₅—COOH], suberic acid [HOOC—(CH₂)₆—COOH], azelaic acid [HOOC—(CH₂)₇—COOH], sebacic acid [HOOC—(CH₂)₈—COOH], undecanedioic acid [HOOC—(CH₂)₉—COOH], dodecandioic acid [HOOC—(CH₂)₁₀—COOH], tridecanedioic acid [HOOC—(CH₂)₁₁—COOH], tetradecandioic acid [HOOC—(CH₂)₁₂—COOH], octadecandioic acid [HOOC—(CH₂)₁₆—COOH].

Yet, acids (AL) which can be used include cycloaliphatic-group containing acids, including notably 1,4-cyclohexane dicarboxylic acid, 1,3-cyclohexane dicarboxylic acids, as cis or trans diastereoisomers, possibly in admixture.

According to certain embodiments, acids (DA) comprising ionisable groups may be used [acids (IDA)] as polycondensation monomers of polyamide (A); among these ionisable groups, mention can be notably made of phenolic hydroxylic groups, sulfonic groups (generally aromatic sulfonic groups), phosphonic groups, onium groups (including phosphonium and ammonium groups) and the like. Non-limiting examples of acids (IDA) of this type which can be used within the frame of the present invention are notably 4-hydroxyisophthalic acid, 5-hydroxyisophthalic acid, 2-hydroxyterephthalic acid, 2,5-dihydroxyterephthalic acid, 4,6-dihydroxyisophthalic acid, 5-sulfoisophthalic acid (and salts thereof, e.g. Li, K, Na, Ag salts), and 2-sulfoterephthalic acid (and salts thereof, e.g. Li, K, Na, Ag salts).

Acids (IDA) including ionisable groups may be used in combination with acids (AR) and/or (AL), as above detailed.

The amine (NN) is generally selected from the group consisting of aliphatic diamines (NNa), aromatic diamines (NNar) and mixtures thereof.

Said aliphatic diamines (NNa) may be or include aliphatic alkylene diamines (NNaa), having 2 to 18 carbon atoms and/or maybe or include a cycloaliphatic diamine, i.e. a diamine comprising a cycloaliphatic group having 2 to 18 carbon atoms [amine (NNca)].

Said aliphatic alkylene diamine (NNaa) is advantageously selected from the group consisting of 1,2-diaminoethane, 1,2-diaminopropane, propylene-1,3-diamine, 1,3-diaminobutane, 1,4-diaminobutane, 1,5-diaminopentane, 1,5-diamino-2-methylpentane, 1,4-diamino-1,1-dimethylbutane, 1,4-diamino-1-ethylbutane, 1,4-diamino-1,2-dimethylbutane, 1,4-diamino-1,3-dimethylbutane, 1,4-diamino-1,4-dimethylbutane, 1,4-diamino-2,3-dimethylbutane, 1,2-diamino-1-butylethane, 1,6-diaminohexane, 1,7-diaminoheptane, 1,8-diamino-octane, 1,6-diamino-2,5-dimethylhexane, 1,6-diamino-2,4-dimethylhexane, 1,6-diamino-3,3-dimethylhexane, 1,6-diamino-2,2-dimethylhexane, 1,9-diaminononane, 1,6-diamino-2,2,4-trimethylhexane, 1,6-diamino-2,4,4-trimethylhexane, 1,7-diamino-2,3-dimethylheptane, 1,7-diamino-2,4-dimethylheptane, 1,7-diamino-2,5-dimethylheptane, 1,7-diamino-2,2-dimethylheptane, 1,10-diaminodecane, 1,8-diamino-1,3-dimethyloctane, 1,8-diamino-1,4-dimethyloctane, 1.8-diamino-2,4-dimethyloctane, 1,8-diamino-3,4-dimethyloctane, 1.8-diamino-4,5-dimethyloctane, 1.8-diamino-2,2-dimethyloctane, 1.8-diamino-3,3-dimethyloctane, 1,8-diamino-4,4-dimethyloctane, 1,6-diamino-2,4-diethylhexane, 1,9-diamino-5-methylnonane, 1,11-diaminoundecane and 1,12-diaminododecane, 1,13-diaminotridecane, 2,5-bis(aminomethyl)tetrahydrofurane, N-methyl-bis-hexamethylene-triamine.

The aliphatic alkylene diamine (NNaa) preferably comprises at least one diamine selected from the group consisting of linear alkylene diamines selected from 1,6-diaminohexane, 1,8-diamino-octane, 1,10-diaminodecane, 1,12-diaminododecane and mixtures thereof. More preferably, the linear alkylene diamine comprises at least one diamine selected from the group consisting of 1,6-diaminohexane, 1,10-diaminodecane and mixtures thereof. Even more preferably, the linear alkylene diamine is 1,6-diaminohexane.

According to other embodiment's, at least one of the amine (NN) is a cycloaliphatic diamine, i.e. a diamine comprising a cycloaliphatic group [amine (NNca)]; the amine (NNca) is generally selected from the group consisting of isophoronediamine, bis(3,5-dialkyl-4-aminocyclohexyl)methane, bis(3,5-dialkyl-4-aminocyclohexyl)ethane, bis(3,5-dialkyl-4-aminocyclohexyl) propane, bis(3,5-dialkyl-4-aminocyclohexyl) butane, bis(3-methyl-4-aminocyclohexyl)methane, p-bis(aminocyclohexyl)methane, isopropylidenedi(cyclohexylamine), 4,4′-diamino-3,3′-dimethyldicyclohexylmethane, 1,3-bis-(aminomethyl)-cyclohexane, and 1,4-bis-(aminomethyl)-cyclohexane.

The aromatic diamine (NNar) is preferably selected from the group consisting of meta-phenylene diamine, meta-xylylene diamine and para-xylylene diamine.

According to certain other embodiments, at least one of the amine (NN) comprises ethereal bonds can be used [amine (NNE)] as polycondensation monomers of polyamide (A); exemplary embodiments of amine (NNE), otherwise referred to as polyetherdiamines are notably diamines comprising moieties of formula: —(OCH₂—CHR^{J})ₙ—, with R^{J} being H or a C₁-C₃ alkyl group, preferably —CH₃, and n being an integer of 1 to 15 and diamines comprising moieties of formula: —(O—C(R′^{J})(R″^{J}))ₘ—O—, with R′^{J} and R″^{J}, equal to or different from each other and at each occurrence, being H or a C₁-C₃ alkyl group, preferably —CH₃, and m being an integer of 1 to 15.

Aminoacid (AN) suitable for use for the manufacture of polyamide (A) can be selected from the group consisting of 6-amino-haxanoic acid, 9-aminononanoic acid, 10-aminodecanoic acid, 11-aminoundecanoic acid, 12-aminododecanoic acid, 13-aminotridecanoic acid.

It is still within the scope of the invention the addition to any of mixtures (M1), (M2), (M3), and their combinations, of one or more than one polyfunctional acid/amine monomers comprising more that two carboxylic acid and amine groups, e.g. polycarboxylic acid having three or more carboxylic acid groups, polyamines having three or more amine groups, polyfunctional diacid including two carboxylic groups and one or more amine groups, polyfunctional diamine including two amine groups and one or more carboxylic acid groups. Incorporation of said polyfunctional acid/amine monomers generally lead to branched structures, star-like or tree-like, such as those notably described in WO 97/24388 (NYLTECH ITALIA) 7/10/1997 and in WO 99/64496 (NYLTECH ITALIA) 16/12/1999.

It is also further understood that one or more than one end capping agent [agent (M)] can be added to any of mixtures (M1), (M2), (M3), and their combinations for the manufacture of polyamide (A), without this departing from the scope of the invention. The agent (M) is generally selected from the group consisting of an acid comprising only one reactive carboxylic acid group [acid (MA)] and an amine comprising only one reactive amine group [agent (MN)].

Acid (MA) is preferably selected from the group consisting of acetic acid, propionic acid, butyric acid, valeric acid, caproic acid, caprylic acid, lauric acid, stearic acid, cyclohexanecarboxylic acid, benzoic acid, 3-sulfobenzoic acid (and salts thereof, e.g. Li, K, Na, Ag salts), 4-sulfobenzoic acid (and salts thereof, e.g. Li, K, Na, Ag salts), preferably from acetic acid and benzoic acid.

Amine (MN) is preferably selected from the group consisting of methylamine, ethylamine, butylamine, hexylamine, octylamine, benzylamine, aniline, toluidine.

Polyamides (PA) which are preferred are:
(A1) semi-aromatic polyamides comprising, preferably consisting of, units which are the condensation product of mixtures comprising:
at least an aromatic diacid (AR), as above described (and derivatives thereof), possibly in combination with an aliphatic diacid (AL), as above described (and derivatives thereof); and
at least an aliphatic diamine [amine (NNa)](and derivatives thereof), as above described; the aliphatic diamine may be an aliphatic alkylene diamine, or a cycloaliphatic diamine, as above explained;
(A3) semi-aromatic polyamides comprising, preferably consisting of, recurring units which are the condensation products of mixtures comprising:
at least one aliphatic diacid (AL), as above described (and derivatives thereof), and
at least one aromatic diamine (and derivatives thereof).

Representative polyamides (PA) of type (A1) are:
polyamides comprising, preferably consisting of, units which are the condensation product of mixtures of 1,6-diaminohexane and terephthalic acid, possibly in combination with isophthalic acid, that is to say resulting polycondensation product being a polyamide 6T or a polyamide 6T/6I;
polyamides comprising, preferably consisting of, units which are the condensation product of mixtures of 1,6-diaminohexane, 1,10-decamethylenediamine, and, possibly, 1,3-bis-(aminomethyl)-cyclohexane, and terephthalic acid, that is to say resulting polycondensation product being a polyamide 6T/10T or a polyamide 6T/10T/BACT
polyamides comprising, preferably consisting of, units which are the condensation product of mixtures of 1,6-diaminohexane, adipic acid and terephthalic acid, possibly in combination with isophthalic acid, that is to say resulting polycondensation product being a polyamide 6T/66 or a polyamide 6T/6I/66;
polyamides comprising, preferably consisting of, units which are the condensation product of mixtures of 1,6-diaminohexane, 1,3-bis-(aminomethyl)-cyclohexane (BAC), 1,4-cyclohexanedicarboxylic acid (cis, trans or cis/trans mixtures) (CHDA), terephthalic acid, and that is to say resulting polycondensation product being a polyamide 6T/BACT/6CHDA/BACCHDA.

Representative polyamides of type (A2) are:
polyamides comprising, preferably consisting of, units which are the condensation product of mixtures of m-xylenediamine (MXDA) and adipic acid, that is to say resulting polycondensation product being a polyamide MXD6.

### The Poly(Arylene Sulphide) Polymer or Polymer (PAS)

The poly(arylene sulfide) (“PAS”) polymer comprises recurring units (R_{PAS1}) represented by the following formula:

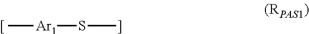

wherein
—Ar₁— is selected from the group of formulae consisting of:

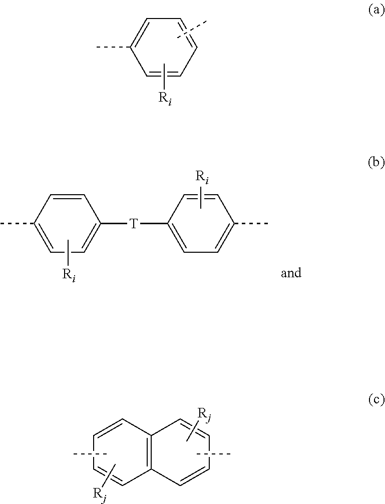

wherein:
R, at each instance, is independently selected from the group consisting of a
C₁-C₁₂ alkyl group, a C₇-C₂₄ alkylaryl group, a C₇-C₂₄ aralkyl group, a C₆-C₂₄ arylene group, and a C₆-C₁₈ aryloxy group;
T is selected from the group consisting of a bond, —CO—, —SO₂—, —O—, —C(CH₃)₂—, —C(CF₃)₂—, phenyl and —CH₂—;
i, at each instance, is an independently selected integer from 0 to 4;
j, at each instance, is an independently selected integer from 0 to 3.

In formulae (a), (b) and (c), when i or j is zero, the corresponding benzyl rings are unsubstituted. Similar notation is used throughout the present description. Additionally, each formula (a) to (c) contains two dashed bonds, where one bond is to the explicit sulfur atom in the recurring unit (R_{PAS1}) and the other is a bond to an atom outside the recurring unit (R_{PAS1}) (e.g. an adjacent recurring unit). Analogous notation is used throughout.

Preferably, —Ar₁— is represented by either formula (a) or (b), more preferably by formula (a).

More preferably, —Ar₁— is represented by any of the following formulae:

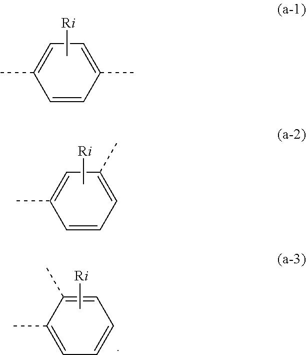

Still more preferably, —Ar₁— is represented by any of formulae (a-1), (a-2) and (a-3), where i is zero.

When units (R_{PAS1}) having —Ar₁— of formula (a-1) are present in combination with units whereas —Ar₁— is of any of formulae (a-2) and/or (a-3), the total concentration of recurring units (R_{PAS1}) whereas —Ar₁— is of any of formulae (a-2) and (a-3) in the polymer (PAS) is at most 10 mol %, at most 5 mol %, at most 3 mol %, at most 1 mol %, based on total amount of units (R_{PAS1}) whereas —Ar₁— is of any of formulae (a-1), (a-2) and (a-3).

Polymer (PAS) having units (R_{PAS1}) of formula (a1) where i is zero, as described above, i.e. having units (R_{PAS1}) of formula:

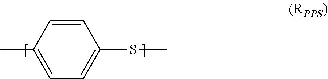

is referred to as poly(phenylene sulfide) (PPS) polymer.

Polymer (PPS) may additionally comprise units of any of formulae:

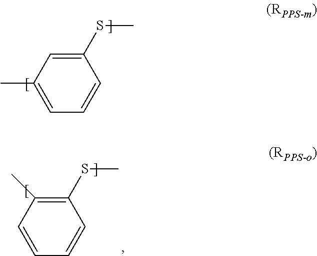

being understood that when polymer (PPS) further comprises units (R_{PPS-m}) and/or (R_{PPS-o}), the total concentration of recurring units (R_{PPS-m}) and/or (R_{PPS-o}) in the polymer (PPS) is at most 10 mol %, at most 5 mol %, at most 3 mol %, at most 1 mol %, based on total amount of units (R_{PPS}), (R_{PPS-m}) and (R_{PPS-o}).

In some embodiments, the total concentration of recurring units (R_{PAS1}) in the polymer (PAS) is at least 50 mol %, at least 60 mol %, at least 70 mol %, at least 80 mol %, at least 90 mol %, at least 95 mol %, at least 98 mol %, at least 99 mol % or at least 99.9 mol %.

In some embodiments, polymer (PAS) may include recurring units (R_{PAS2}) different from recurring units (R_{PAS1}), said recurring units (R_{PAS2}) being represented by the following formula:

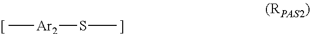

Wherein:
—Ar₂— is represented by the following formula:

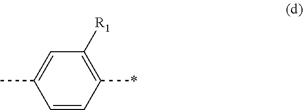

wherein R₁ is a C₁ to C₁₀ linear or branched alkyl group, preferably R₁ is —CH₃.

In formula (d), the dashed bond having a “*” indicates the bond to the explicit sulfur atom in recurring unit (R_{PAS2}) and the dashed bond without the “*” indicates a bond to an atom outside the recurring unit (R_{PAS2}). In other terms, in unit (R_{PAS2}), the R₁ substituent is in ortho position with respect to the —S-moiety.

Of course, in some embodiments, the polymer (PAS) can have additional recurring units, each distinct from each other and distinct from recurring units (R_{PAS1}) and (R_{PAS2}).

In some embodiments, the total concentration of recurring units (R_{PAS1}) and (R_{PAS2}) in the polymer (PAS) is at least 50 mol %, at least 60 mol %, at least 70 mol %, at least 80 mol %, at least 90 mol %, at least 95 mol %, at least 98 mol %, at least 99 mol % or at least 99.9 mol %.

As used herein, the molar concentration of recurring units in a polymer is relative to the total number of recurring units in that polymer, unless explicitly stated otherwise.

In some embodiments, the concentration of recurring unit (R_{PAS1}) in the polymer (PAS) is at least 50 mol %, at least 60 mol %, at least 70 mol %, at least 80 mol %, at least 85 mol %, at least 88 mol %, at least 90 mol %, at least 95 mol %, at least 97 mol %, at least 98 mol %, at least 98.5 mol %, or at least 99 mol %.

In some embodiments, the concentration of recurring unit (R_{PAS2}) in the polymer (PAS) may be of at least 0.5 mol %, at least 1 mol %, at least 1.5 mol %, at least 2 mol % or at least 2.5 mol %. In some embodiments, the concentration of recurring unit (R_{PAS2}) is no more than 15 mol %, no more than 12 mol %, no more than 10 mol %, or no more than 8 mol %.

In some embodiments, the number of moles of recurring unit (R_{PAS2}) in the polymer (PAS) may be from 0.5 mol % to 15 mol %, from 0.5 mol % to 12 mol %, from 0.5 mol % to 10 mol %, from 0.5 mol % to 8 mol %, from 1 mol % to 15 mol %, from 1 mol % to 12 mol %, from 1 mol % to 10 mol %, from 1 mol % to 8 mol %, from 2 mol % to 8 mol % or from 2.5 mol % to 8 mol %.

In some embodiments, the ratio of the number of recurring unit (R_{PAS2}) to the total number of recurring units (R_{PAS1}) and (R_{PAS2}) in the polymer (PAS) may be of at least 1 mol %, at least 1.5 mol %, at least 2 mol % or at least 2.5 mol %.

In some embodiments, the ratio of the number of recurring unit (R_{PAS2}) to the total number of recurring units (R_{PAS1}) and (R_{PAS2}) is no more than 15 mol %, no more than 12 mol %, no more than 10 mol %, or no more than 8 mol %.

While polymer (PAS) may comprise units (R_{PAS2}), preferred are embodiments whereas polymer (PAS) does not comprise any unit (R_{PAS2}), as detailed above.

According to these embodiments, the concentration of recurring units (R_{PAS1}) in the polymer (PAS) is at least 50 mol %, at least 60 mol %, at least 70 mol %, at least 80 mol %, at least 90 mol %, at least 95 mol %, at least 98 mol %, at least 99 mol % or at least 99.9 mol %.

Most preferably, polymer (PAS) essentially consists of recurring units (R_{PAS1}), as detailed above. The expression “essentially consisting”, when used for characterizing constituent moieties of polymer (PAS) is meant to indicate that minor amounts of spurious units (e.g. less than 0.1 mol %), impurities or chain ends may be present, without this modifying the advantageous attributes of polymer (PAS).

Most preferably, polymer (PAS) is a polymer (PPS), as described above, and most preferably is a polymer (PPS) essentially consisting of units (R_{PAS1}) of formula (R_{PPS}), as detailed above.

The polymer (PAS) may have a melt flow rate (at 315.6° C. under a weight of 1.27 kg according to ASTM D1238, procedure B) of at most 700 g/10 min, more preferably of at most 500 g/10 min, even more preferably of at most 200 g/10 min, still more preferably of at most 50 g/10 min, yet more preferably of at most 35 g/10 min.

Preferably, the polymer (PAS) has a melt flow rate (at 315.6° C. under a weight of 1.27 kg according to ASTM D1238, procedure B) of at least 1 g/10 min, more preferably of at least 5 g/10 min, even more preferably of at least 10 g/10 min, still more preferably of at least 15 g/10 min.

The polymer (PAS) can be amorphous or semi-crystalline. As used herein, an amorphous polymer has an enthalpy of fusion (“ΔH_{f}”) of no more than 5 Joules/g (“J/g”). The person of ordinary skill in the art will recognize that when the polymer (PAS) is amorphous, it lacks a detectable temperature of melting (Tm). Accordingly, where a polymer (PAS) has a Tm, the person of ordinary skill in the art will recognize that it refers to semi-crystalline polymer. Preferably, the polymer (PAS) is semi-crystalline. In some embodiments, the polymer (PAS) has a ΔH_{f} of at least 10 J/g, at least 20 J/g, at least, or at least 25 J/g. In some embodiments, the polymer (PAS) has a ΔH_{f} of no more than 90 J/g, no more than 70 J/g or no more than 60 J/g. In some embodiments, the polymer (PAS) has a ΔH_{f} of from 10 J/g to 90 J/g or from 20 J/g to 70 J/g. ΔH_{f} can be measured by differential scanning calorimeter (DSC), according to ASTM D3418.

Preferably, the polymer (PAS) has a melting point of at least 240° C., more preferably of at least 248° C., even more preferably of at least 250° C., when determined by differential scanning calorimeter (DSC) according to ASTM D3418.

Preferably, the polymer (PAS) has a melting point of at most 320° C., more preferably of at most 300° C., even more preferably of at most 295° C., when determined by differential scanning calorimeter (DSC) according to ASTM D3418.

Preferably, the polymer (PAS) has a weight-average molecular weight (Mw) of at least 40,000 g/mol, preferably 45,000 g/mol, more preferably of at least 50,000 g/mol, even more preferably of at least 55,000 g/mol, as determined by gel permeation chromatography.

Preferably, the polymer (PAS) has a weight-average molecular weight (Mw) of at most 120,000 g/mol, more preferably of at most 110,000 g/mol, even more preferably of at most 100,000 g/mol, still more preferably of at most 90,000 g/mol, as determined by gel permeation chromatography.

Preferably, the polymer (PAS) is such that it exhibits, as a main technical feature, a calcium content of less than 200 ppm, as measured by X-ray Fluorescence (XRF) analysis calibrated with standards of known calcium content as determined by Inductively Coupled Plasma Optical Emission Spectrometry (ICP-OES) according to ASTM UOP714-07.

Exemplary polymers (PAS) are commercially available as RYTON® PPS from Solvay Specialty Polymers USA, L.L.C.

The polymer (PAS) may advantageously comprise at least one functional group at least one of its chain ends. According to some embodiments, the polymer (PAS) has functional groups at each end of its chain. As used herein, the term “chain” is intended to denote the longest series of covalently bonded atoms that together create a continuous chain in a molecule.

When present, preferably, the functional groups of polymer (PAS) are according to formula (I) below:

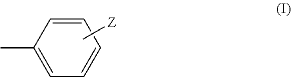

wherein Z is selected from the group consisting of halogen atoms (e.g. chlorine), carboxyl group, amino group, hydroxyl group, thiol group, acid anhydride group, isocyanate group, amide group, and derivatives thereof such as salts of sodium, lithium, potassium, calcium, magnesium, zinc.

When present, preferably, the functional groups exhibit reactivity towards the polymer (POS), and they are selected from the group consisting of carboxyl group, amino group, hydroxyl group, thiol group, acid anhydride group, isocyanate group, amide group, and derivatives thereof such as salts of sodium, lithium, potassium, calcium, magnesium, zinc.

Preferably, the functional groups are selected from the group consisting of hydroxyl group, thiol group, hydroxylate and thiolate.

Preferably, the polymer (PAS) is linear.

When functional groups are present, preferably, the polymer (PAS) is linear and comprises at least one reactive functional group at least one chain end. In an embodiment, the polymer (PAS) is linear and comprises at least one reactive functional group at each end of its chain.

### The Flat Glass Fibers

The polymer composition (C) further includes flat glass fibers.

In the present invention, the expression “flat glass fibers” is intended to denote glass fibers having a non-circular cross section. Flat glass fibers suitable for being used as reinforcing filler in the composition of the present invention may have any non-circular cross section such as an elliptical section, oblong-circular section, rectangle section, a section in which half rounds are connected to both short sides of a rectangle, and cocoon section.

The aspect ratio of said non-circular cross section of the flat glass fibers is advantageously from 1.0 to 10, preferably from 1.5 to 7.0, more preferably from 2.0 to 6.0, most preferably from 3.0 to 5.0.

The aspect ratio according to the present invention can be determined by analyzing an image obtained by observing a cross section of the flat glass fiber with a scanning electron microscope (SEM), and circumscribing the non-circular section of the flat glass fiber with a hypothetical rectangle matching the cross-sectional longest and shortest dimensions. The aspect ratio is obtained by calculating A (=length of Ra)/B (=length of Rb) wherein A and B are the length of a long side Ra and a short side Rb of the said rectangle circumscribed to the flat glass fiber in the observed image. The aspect ratio is determined as an average of a multiplicity of such determinations, measuring the individual shortest and longest dimensions in at least 10 different images of cross-sections of flat glass fibers.

Glass fibers are silica-based glass compounds that contain several metal oxides which can be tailored to create different types of glass. The main oxide is silica in the form of silica sand; the other oxides such as calcium, sodium and aluminum are incorporated to reduce the melting temperature and impede crystallization. The glass fibers may be added as endless fibers or as chopped glass fibers. All glass fiber types, such as A, C, D, E, M, S, R, T glass fibers (as described in chapter 5.2.3, pages 43-48 of Additives for Plastics Handbook, 2nd ed, John Murphy), or any mixtures thereof or mixtures thereof may be used. For example, E glass fibers typically have an elastic modulus of at least 68, preferably at least 70, more preferably at least 72 GPa, as measured according to ASTM D2343. R, S and T glass fibers are high modulus glass fibers that have typically an elastic modulus of at least 76, preferably at least 78, more preferably at least 80, and most preferably at least 82 GPa as measured according to ASTM D2343.

E, R, S and T glass fibers are well known in the art. They are notably described in Fiberglass and Glass Technology, Wallenberger, Frederick T.; Bingham, Paul A. (Eds.), 2010, XIV, chapter 5, pages 197-225. R, S and T glass fibers are composed essentially of oxides of silicon, aluminum and magnesium. In particular, those glass fibers comprise typically from 62-75 wt. % of SiO₂, from 16-28 wt. % of Al₂O₃ and from 5-14 wt. % of MgO. To the contrary of the regular E-glass fibers widely used in polymer compositions, R, S and T glass fibers comprise less than 10 wt. % of CaO.

In some embodiments, the flat glass fibers are chopped fibers which have an average length of from 3 mm to 50 mm. In some such embodiments, the glass fiber has an average length of from 3 mm to 10 mm, from 3 mm to 8 mm, from 3 mm to 6 mm, or from 3 mm to 5 mm. In alternative embodiments, the glass fiber has an average length of from 10 mm to 50 mm, from 10 mm to 45 mm, from 10 mm to 35 mm, from 10 mm to 30 mm, from 10 mm to 25 mm or from 15 mm to 25 mm. The average length of the glass fiber can be taken as the average length of the glass fiber prior to incorporation into the polymer composition or can be taken as the average length of the glass fiber in the polymer composition.

In some embodiments, the glass fiber has a cross-sectional longest dimension of at least 15 μm, preferably at least 20 μm, more preferably at least 22 μm, still more preferably at least 25 μm. Additionally or alternatively, in some embodiments, the glass fiber has a cross-sectional longest dimension of at most 40 μm, preferably at most 35 μm, more preferably at most 32 μm, still more preferably at most 30 μm. In some embodiments, glass fiber has a cross-sectional longest dimension from 15 μm to 35 μm, preferably from 20 to 30 μm and more preferably from 25 μm to 29 μm. In some embodiments, the glass fiber has a cross-sectional shortest dimension of at least 4 μm, preferably at least 5 μm, more preferably at least 6 μm, still more preferably at least 7 μm. Additionally or alternatively, in some embodiments, the glass fiber has a cross-sectional shortest dimension of at most 25 μm, preferably at most 20 μm, more preferably at most 17 μm, still more preferably at most 15 μm. In some embodiments, the glass fiber has a cross-sectional shortest diameter of from 5 μm to 20 μm, preferably from 5 μm to 15 μm and more preferably from 7 μm to 11 μm.

According to certain embodiments, the glass fiber may be coated with a predetermined material on a surface thereof in order to prevent reaction with the polymer(s) and other ingredients of the polymer composition (C) and/or to improve the degree of impregnation/adhesion to the polymer. The coating material may change overall fluidity, impact strength, and the like of a glass fiber-reinforced polymer composition. Suitable materials for coating glass fiber and affecting the fluidity, impact strength, and the like of a glass fiber-reinforced polymer composition are well-known to a person of ordinary skill in the art and may be selected without undue experimentation depending on the desired properties of the resultant composition.

In addition to the above mentioned flat glass fiber, the polymer composition (C) may further comprise additional reinforcing fillers, which may be fibrous or particulate fillers.

Preferably, the additional reinforcing filler is selected from mineral fillers (such as talc, mica, kaolin, calcium carbonate, calcium silicate, magnesium carbonate, glass flakes, glass beads), glass fiber (different from the above mentioned glass fiber), carbon fibers, synthetic polymeric fiber, aramid fiber, aluminum fiber, titanium fiber, magnesium fiber, boron carbide fibers, rock wool fiber, steel fiber, wollastonite, etc. Still more preferably, it is selected from mica, kaolin, calcium silicate, magnesium carbonate, wollastonite and glass fibers different from the above mentioned glass fiber having a non-circular cross section and a specific elastic modulus.

In the polymer composition (C), the flat glass fibers are present in an amount of advantageously at least 10 wt. %, preferably at least 12 wt. %, more preferably at least 15 wt. %, still more preferably at least 17 wt. %, even more preferably at least 18 wt. %, yet even more preferably at least 20 wt. %, and most preferably at least 25 wt. %, or even at least 30 wt. %, based on the total weight of the polymer composition (C).

Said flat glass fiber are also present in an amount of advantageously at most 60 wt. %, preferably at most 58 wt. %, more preferably at most 55 wt. %, still more preferably at most 50 wt. %, even more preferably at most 48 wt. %, and most preferably at most 45 wt. %, yet even more preferably at most 40 wt. % based on the total weight of the polymer composition (C).

Preferably, the flat glass fiber are present in an amount ranging from 10 to 60 wt. %, more preferably from 15 to 55 wt. %, based on the total weight of the polymer composition (C).

The flat glass fiber concentration is from 10 wt. % to 60 wt. %. In some embodiments, the flat glass fiber concentration is from 10 wt. % to 55 wt. %, from 10 wt. % to 50 wt. %, from 15 wt. % to 55 wt. %, from 25 wt. % to 45 wt. % or from 30 wt. % to 40 wt. %.

### The Metal Insert

Bronze, aluminum, an aluminum alloy, a brass alloy, zinc, copper, a copper alloy, lead, a stainless steel, a carbon steel or a galvanized steel come into consideration as the metal of the metal insert, for example. Any other metal may be used as constituting material of the metal insert.

The metal insert can in particular be a plug connection element, a sensor or a conductor structure, in particular a lead frame, or can be a metallic strip or a bar or any other shaped rigid conductor.

The plug connection element can in particular be a plug pin or a plug socket which is intended to be assembled with the plastic component. Since the plug connection element is provided for connecting to a corresponding plug connection element, for example a plug pin for connecting to a corresponding plug socket, the plug connection element is only intended to be partly overmoulded with plastic component, while a part of the surface of the plug connection element is exposed, in order to enable a plug connection to be established.

The sensor can in particular be a sensor with an exposed area, i.e. with an area which is not intended to be embedded in the plastic component. In this way, the sensor can directly make contact with its surroundings and in this way measure information concerning the surroundings without being hindered by the plastic component. For example, the sensor can be a temperature sensor or an optical sensor.

The conductor structure can, for example, be a lead framework of a circuit with a plurality of electrical contact points for connecting electrical components and with a plurality of lead connections which electrically connect the contact points to one another. Such a lead framework is embedded in the assembly (MP) in particular in such a way that at least some of the electrical contact points remain exposed, so that electrical components can be connected to the contact points. Such lead frameworks are, for example, used in motor vehicles in order to interconnect pre-fabricated electrical components to form a circuit.

The conductor structure can in particular also be a lead frame. A lead frame is understood as a metallic lead carrier in the form of a frame or comb which is used for producing chip packages of microchips or other electrical components.

Alternatively, the metal insert can be a structural part, such as a tubular insert for a compressor wheel assembly, intended to be used as central part for engaging a rotatable shaft in impellers e.g. for turbochargers, superchargers and the like.

Still, the metal insert can be a fixing part intended for a plastic bracket, such as, notably, a threaded stud, a threaded insert, a threaded nut. The fixing part may comprise opposing knurls and/or diamond knurling on its surface intended to be adhered to the plastic component. Alternatively, or in addition, the fixing part may comprise a flat base section, typically with though-holes, for increasing pull-out resistance from the plastic component of the bracket.

As another possibility, the metal insert can be a structural or conductive part of a stator or rotor component for an electrical motor.

### The Assembly (MP)

The metal insert of the assembly (MP) comprise areas of its surface not covered by the plastic component, on which, for instance, welding can be carried out, or which can be used for electrical connections or which may be leveraged for any other functionality.

When the assembly (MP) is an insulated busbar, the metal insert can be a metallic strip or a bar; in the busbar of the invention, the plastic component advantageously provides notably electrical insulation, as well as, possibly, mechanical strengths and conformational stability for easy mount-on techniques.

The assembly (MP) can be a compressor wheel assembly comprising:
a metal tubular insert having a shaft bore extending from an inlet end to an outlet end opposed to the inlet end, and including at least one engagement member for engaging a rotatable shaft;
a compressor wheel member made of the polymer composition (C) molded on to the tubular insert, and having a blade array.

Compressor wheel assembly of the invention is used in applications such as turbochargers, superchargers and the like. The shaft rotatably drives the compressor wheel in a direction such that the blade array draws in air axially and discharge that air radially outwardly at an elevated pressure level into a chamber of a compressor housing. The pressurized air is, then, supplied from the chamber to the air intake manifold of an internal combustion engine for admixture and combustion with fuel, all in a well-known manner. The compressor wheel assembly of the present invention desirably provides efficiencies of polymeric structures without issues of creep and distortion.

The assembly (MP) can be a plastic bracket of any possible three-dimensional shape, in particular for use as mounting fixtures.

The assembly (MP) can be a part of a stator component for an electrical motor; more specifically, it can be a stator segment whereas the metal insert provides for electrical connection and the plastic component provides for insulation, suitable for hosting magnet wires with high coil densities, or it can be a skewed rotor stator, either internal or external, with plastic component insulation. Still the assembly (MP) can be a rotor of an electrical motor.

### Method of Making the Assembly (MP)

Another object of the present invention is a method of making the assembly (MP) as detailed above, said method comprising assembling the metal insert and the plastic component.

The most widely used technique for the manufacturing the assembly (MP) is insert molding. According to this technique, the method of making the assembly (MP) comprises:
Step 1—a step of placing a pre-molded metal insert into a mold; and
Step 2—a step of molding the polymer composition (C) in said mold comprising the sais pre-molded metal insert.
   As it is generally understood that when the surface of the insert is not clean, loss of adhesion between the plastic component and insert may occur, metal insert will generally protected from contamination sources like dirt, dust, skin oil (so hand protection should be worn when handling the inserts), mold release agents, lubricants, and the like.

According to certain embodiments, the first step may comprise a step of pre-heating the metal insert. The optimum insert temperature will vary, depending on both the metal insert material and the type of polymer composition (C) used. Yet, this pre-heating step is not mandatory, and may be skipped.

Texturing or pre-treating the surface of the metal insert to be covered by the plastic component may improve adhesion either through mechanical interlock or through chemical phenomena.

It may hence be advantageous to impinge the surface of the metal insert with a plasma treatment, possibly in the presence of a compound facilitating adhesion; any type of adhesive compound may be used, such as a silane compound.

Hence, the first step may include using a metal insert which has been submitted to any of such pre-treatments before being placed in the mold.

Said second step of the method includes generally injecting a shot of the polymer composition (C) in the molten phase into the mold comprising the insert; solidifying the polymer composition (C) while in contact with the metal insert; and removing the so-obtained assembly (MP) from the mold.

The technique of insert molding can make use of conventional single shot Injection Molding equipment's; the mold used shall accommodate the metal insert and keep the same in place during the injection of the molten polymer.

### Use of the Assembly (MP)

As said, the assemblies of the invention find utility in a large array of industries and applications. Because of their ability to withstand thermal shock without critical failures, they are particularly adapted for uses as automotive components, in particular in under-the-hood applications.

Significantly, the assembly (MP) of the invention, and particularly, a busbar or a stator/rotor component of an electrical motor according to the invention can be advantageously used in e-mobility applications.

Should the disclosure of any patents, patent applications, and publications which are incorporated herein by reference conflict with the description of the present application to the extent that it may render a term unclear, the present description shall take precedence.

The invention will be now described with reference to the following examples, whose purpose is merely illustrative and not limiting the scope of the present invention.

### Manufacture of the Polymer Compositions

The compounds comprising ingredients listed in the Tables below have been manufactured by melt compounding through extrusion using a Coperion® ZSK-26 extruder, and prepared under the form of pellets.

### Comparative Example 1

| MATERIAL | Weight % | NATURE |
|---|---|---|
| Polyphthalamide | 61.7% | Polyphthalamide 6T/BACT/6CHDA/BACCHDA |
| | | commercially available as AMODEL ® A-9004B from |
| | | Solvay Specialty Polymers USA, LLC |
| ADDITIVE | 0.3% | Linear Low density Polyethylene (LLDPE) GRSN-9820 |
| PIGMENT | 1.5% | CARBON BLACK CPTA-25759 |
| STABILIZER | 0.25% | hindered phenolic antioxidant ADK AO-80 from |
| | | ADEKA |
| STABILIZER | 0.25% | Phosphite antioxidant ADK PEP-36 from ADEKA |
| IMPACT MODIFIER | 3.0% | block copolymer based on styrene and |
| | | ethylene/butylene with a polystyrene content of |
| | | 30%, available as KRATON ® FG 1901 GT from Kraton |
| | | Corporation |
| GLASS FIBER | 33.0% | Circular cross-section (aspect ratio = 1) chopped |
| | | strand fiberglass ChopVantage ® HP3610 |
| | | commercially available from PPG |

### Example 1

| MATERIAL | Weight % | NATURE |
|---|---|---|
| Polyphthalamide | 61.7% | Polyphthalamide 6T/BACT/6CHDA/BACCHDA |
| | | commercially available as AMODEL ® A-9004B from |
| | | Solvay Specialty Polymers USA, LLC |
| ADDITIVE | 0.3% | Linear Low density Polyethylene (LLDPE) GRSN-9820 |
| PIGMENT | 1.5% | CARBON BLACK CPTA-25759 |
| STABILIZER | 0.25% | hindered phenolic antioxidant ADK AO-80 from |
| | | ADEKA |
| STABILIZER | 0.25% | Phosphite antioxidant ADK PEP-36 from ADEKA |
| IMPACT MODIFIER | 3.0% | block copolymer based on styrene and |
| | | ethylene/butylene with a polystyrene content of |
| | | 30%, available as KRATON ® FG 1901 GT from Kraton |
| | | Corporation |
| GLASS FIBER | 33.0% | Oval cross-section (aspect ratio = 4) chopped strand |
| | | fiberglass CSG 3PA-820 commercially available from |
| | | NIttobo |

### Comparative Example 2

| MATERIAL | Weight % | Nature |
|---|---|---|
| IMPACT MODIFIER | 6.0% | Ethylene/glycidyl methacrylate copolymer |
| | | LOTADER ®AX8840 from SK |
| GLASS FIBER | 31.0% | Circular cross-section (aspect ratio = 1) chopped strand |
| | | fiberglass ECS 03 T779H commercially available from Nippon |
| | | Electric Glass |
| ADDITIVE | 0.25% | High density polyethylene - HDPE 6007G POWDER |
| PIGMENT | 0.5% | Carbon Black AROSPERSE ® 11W BEADS from Orion |
| | | Engineered Carbons |
| Polyphenylenesulfide | 16.25% | Ryton ® QA281N (granular powder) polyphenylene sulfide |
| | | from Solvay |
| Polyphenylenesulfide | 45.0% | Ryton ® QA321N (granular powder) polyphenylene sulfide |
| | | from Solvay |
| STABILIZER | 0.5% | Sterically hindered phenol stabilizer |
| ADDITIVE | 0.5% | Ureido-silane coupling agent |

### Example 2

| MATERIAL | Weight % | Nature |
|---|---|---|
| IMPACT MODIFIER | 6.0% | Ethylene/glycidyl methacrylate copolymer |
| | | LOTADER ®AX8840 from SK |
| GLASS FIBER | 31.0% | Oval cross-section (aspect ratio = 4) chopped strand |
| | | fiberglass CSG 3PA-820 commercially available from NIttobo |
| ADDITIVE | 0.25% | High density polyethylene - HDPE 6007G POWDER |
| PIGMENT | 0.5% | Carbon Black AROSPERSE ® 11W BEADS from Orion |
| | | Engineered Carbons |
| Polyphenylenesulfide | 16.25% | Ryton ® QA281N (granular powder) polyphenylene sulfide |
| | | from Solvay |
| Polyphenylenesulfide | 45.0% | Ryton ® QA321N (granular powder) polyphenylene sulfide |
| | | from Solvay |
| STABILIZER | 0.5% | Sterically hindered phenol stabilizer |
| ADDITIVE | 0.5% | Ureido-silane coupling agent |

### Comparative Example 3

| MATERIAL | Weight % | Nature |
|---|---|---|
| IMPACT MODIFIER | 4.5000% | Ethylene/glycidyl methacrylate copolymer |
| | | LOTADER ®AX8840 from SK |
| GLASS FIBER | 40.0% | Circular cross-section (aspect ratio = 1) chopped strand |
| | | fiberglass ECS 03 T779H commercially available from |
| | | Nippon Electric Glass |
| ADDITIVE | 0.25% | High density polyethylene - HDPE 6007G POWDER |
| PIGMENT | 0.5% | Carbon Black AROSPERSE ® 11W BEADS from Orion |
| | | Engineered Carbons |
| Polyphenylenesulfide | 10.0% | Ryton ® QA281N (granular powder) polyphenylene sulfide |
| | | from Solvay |
| Polyphenylenesulfide | 33.75% | Ryton ® QA321N (granular powder) polyphenylene sulfide |
| | | from Solvay |
| MINERAL ADDITIVE | 10.0% | Calcium carbonate |
| STABILIZER | 0.5% | Sterically hindered phenol stabilizer |
| ADDITIVE | 0.5% | Ureido-silane coupling agent |

### Example 3

| MATERIAL | Weight % | Nature |
|---|---|---|
| IMPACT MODIFIER | 4.5000% | Ethylene/glycidyl methacrylate copolymer |
| | | LOTADER ®AX8840 from SK |
| GLASS FIBER | 40.0% | Oval cross-section (aspect ratio = 4) chopped strand |
| | | fiberglass CSG 3PA-820 commercially available from |
| | | NIttobo |
| ADDITIVE | 0.25% | High density polyethylene - HDPE 6007G POWDER |
| PIGMENT | 0.5% | Carbon Black AROSPERSE ® 11W BEADS from Orion |
| | | Engineered Carbons |
| Polyphenylenesulfide | 10.0% | Ryton ® QA281N (granular powder) polyphenylene sulfide |
| | | from Solvay |
| Polyphenylenesulfide | 33.75% | Ryton ® QA321N (granular powder) polyphenylene sulfide |
| | | from Solvay |
| MINERAL ADDITIVE | 10.0% | Calcium carbonate |
| STABILIZER | 0.5% | Sterically hindered phenol stabilizer |
| ADDITIVE | 0.5% | Ureido-silane coupling agent |

### Manufacture of Metal Plastic Assemblies by Overmolding

The thermal shock performances have been quantified using 2 different molds (A and B) in which metal inserts were overmolded according to the following protocol:

### Mold A

Metal inserts made of S50C carbon steel containing 0.50% of carbon defined in JIS G4051, which had dimensions of 60.7 mm in length, 8.4 mm in width and 2.4 mm in thickness having 0.50 mm as the corner radius, were provided. These metal inserts had two through-holes in thickness direction to hold in a cavity of a tool for injection molding.

The cavity of the tool had 64.0 mm in length, 10.0 mm in width and 4.0 mm in thickness, and two pins to hold the metal piece. The location of the pins was designed to enable the molten plastic to cover entirely the metal insert with 0.80 mm of thickness except gate. A side gate having 3.0 mm thickness and 6.0 mm width was located at the longitudinal distal end.

An injection molding machine having model name of SE50DU manufactured by Sumitomo Heavy Industries Ltd. was used for the injection molding of the plastic assemblies. This machine has 50 tons of clamping force, 22 mm diameter of inline screw, 40 cm³ of cylinder capacity.

Injection molding of the PPS compounds was conducted at 310 to 315° C. as the cylinder temperature, 150° C. as the tool surface temperature, 120 to 200 mm/sec of injection speed at 115 to 150 MPa of injection pressure, with the metal piece pre-inserted in the mold and preheated at 150° C. before the insertion.

Plastic assemblies with metal insert totally covered by PPA were used for the thermal shock test.

### Mold B:

Metal pieces made of Copper Alloy 110 containing 99.9% copper and 0.04% oxygen as defined in ASTM B152, which had dimensions of 130 mm in length, 9.5 mm in width and 3.2 mm in thickness having 0.50 mm of the corner radius, were provided. The copper bars were nickel plated to avoid oxidation during preheating (150° C.), overmolding (melt temperature up to 350° C.) and thermal exposure. To hold the copper bars in the cavity, two steel end blocks were developed that hold two copper bars together and fit into the cavity as a four-part assembly. This provided flexibility to specimen design through the end block customization.

The tool had a central cavity of 80.0 mm in length, 12.5 mm in width and 12.4 mm in thickness, and two cavities to hold the steel end blocks. Also, there were two pins of 4.6 mm diameter (one on each core and cavity side) at the center that support the two copper bars to avoid deflection by injection pressure. Two different gating options were provided: (i) two side gates near the two ends along the length; and (ii) one side gate near one end along the length.

An injection molding machine having model name of Ti-55G2 manufactured by Toyo Machinery and Metal Co. Ltd. was used for the injection molding of the metal-plastic assemblies. This machine has 55 tons of clamping force, 28 mm diameter of inline screw, 60 cm³ of cylinder capacity.

Injection molding of the PPA compounds was conducted at 338° C. as the cylinder temperature, 192° C. as tool surface temperature, 45 mm/sec of injection speed at 110 MPa of injection pressure, with the metal piece pre-inserted in the mold and preheated at 200° C. before the insertion.

Plastic assemblies with metal insert totally covered by PPA were used for the thermal shock test.

### Thermal Shock Test

### Equipment Used:

A Weiss thermal shock TS60 chamber was used to perform the thermal cycling. This equipment is constructed of two independently controlled chambers. One chamber is hot and the other one is cold. A moveable basket can rapidly be transferred between the hot and cold chamber creating a temperature shock of the specimens. Temperature in the hot chamber can be adjusted between +50° C. and +220° C., while the cold chamber can be adjusted between −80° C. and +70° C. The moveable basket moves from one chamber to the other within 10 seconds.

### Experimental Procedure

Sets of five specimens of each injection molded materials were loaded on aluminum racks so that free movement of air exists across the four sides of the specimens. The racks were then placed inside the moveable basket.

The following test protocol was set on the thermal shock chamber:
Hot Chamber T=+150° C.
Cold Chamber T=−40° C.
Time in each chamber: 1 hour
Number of Cycles: 300 cycles

On a daily basis, the thermal shock equipment was paused, specimens were taken out of the chamber and each specimen was visually inspected for presence of failures by cracking. When a specimen was showing such failure, the cracked specimen was put on side and the number of the cycle completed as well as the date were recorded. After full inspection of all specimens, the specimens left intact were placed back in the thermal shock chamber and the programmed cycle was resumed.

### Data Report and Analysis:

When all five specimens reached failure, the average number of cycle to failure was calculated and the min and max cycles to failure for the given set of specimens were also reported.

The results are summarized below:

| Material | Mold Type | Average # Cycles before failure |
|---|---|---|
| Comp. Ex. 2 | Mold A | 441 |
| Ex. 2 | | >635* |
| Comp. Ex. 3 | Mold A | 340 |
| Ex. 3 | | >621* |
| Comp. Ex. 1 | Mold B | 50 |
| Ex. 1 | | 239 |

*At the time the Thermal Shock experiments were stopped, not all the specimens have shown failures; consistently, computations made based on the assumption that # of cycles at the time of termination correspond to # of cycles at failure can only lead to a lower end estimate, which is hence listed as a lower boundary.

1. A metal-plastic assembly [assembly (MP)] comprising:
a metal insert, having a surface; and
a plastic component, in contact with at least a part of said surface of said metal insert, wherein the plastic component is made from a polymer composition [composition (C)] comprising:
at least one polymer selected from the group consisting of a polyamide polymer [polymer (PA)] and a polyarylene sulphide polymer [polymer (PAS)]; and
flat glass fibers [Fibers (FGF)],
wherein:
the assembly (MP) is an insulated busbar, and wherein the metal insert is a metallic strip or a bar;
or
the assembly (MP) is a compressor wheel assembly comprising:
a metal tubular insert having a shaft bore extending from an inlet end to an outlet end opposed to the inlet end, and including at least one engagement member for engaging a rotatable shaft;
a compressor wheel member made of the polymer composition (C) molded on to the tubular insert, and having a blade array;
or
the assembly (MP) is a plastic bracket of a three-dimensional shape for use as mounting fixtures;
or
the assembly (MP) is a part of a stator component or a rotor component for an electrical motor.

2. The assembly (MP) of claim 1, wherein the composition (C) further comprises a toughener in an amount of greater than 1 wt. % and less than 30 wt. %, based on the total weight of the composition (C).

3. The assembly (MP) of claim 1, wherein the metal of the metal insert is any of bronze, aluminum, an aluminum alloy, a brass alloy, zinc, copper, a copper alloy, lead, a stainless steel, a carbon steel and a galvanised steel.

4. The assembly (MP) of claim 1, wherein the polymer composition (C) is a polyamide-based composition wherein polymer (PA) is present in a total amount of greater than 30 wt. %, based on the total weight of the polymer composition (C); and/or in a total amount of less than 95 wt. %, based on the total weight of the polymer composition (C).

5. The assembly of claim 4, wherein the polymer (PA) of the polymer composition (C) comprises recurring units (R_{PA}) derived from polycondensation of a diamine and a diacid of formula (AABB) below, and/or units derived from polycondensation of an aminoacid or lactam, of formula (AB) below: 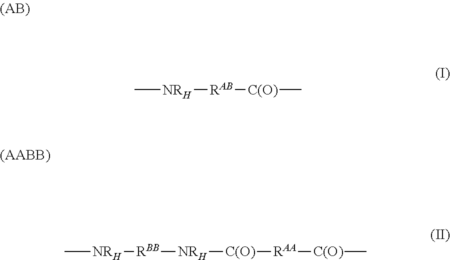
wherein R_{H} is hydrogen or a hydrocarbon group; and R^{AB}, R^{BB}, R^{AA}, equal to or different from each other, are divalent hydrocarbon groups, possibly including one or more than one heteroatom,
wherein
recurring units (I) and (II) of the polyamide (PA) are the condensation product of at least one mixture selected from:
mixtures (M1) comprising at least a diacid [acid (DA)](or derivative thereof) and at least a diamine [amine (NN)](or derivatives thereof);
mixtures (M2) comprising at least a lactam [lactam (L)];
mixtures (M3) comprising at least an aminocarboxylic acid [aminoacid (AN)]; and
combinations thereof.

6. The assembly (MP) of claim 5, wherein said acid (DA) is selected from the group consisting of:
an aromatic dicarboxylic acid comprising two reactive carboxylic acid groups [acid (AR)], which is selected from phthalic acids, including isophthalic acid (IA), and terephthalic acid (TA); 2,5-pyridinedicarboxylic acid 2,4-pyridinedicarboxylic acid, 3,5-pyridinedicarboxylic acid, 2,2-bis(4-carboxyphenyl)propane, bis(4-carboxyphenyl)methane, 2,2-bis(4-carboxyphenyl)hexafluoropropane, 2,2-bis(4-carboxyphenyl)ketone, 4,4′-bis(4-carboxyphenyl)sulfone, 2,2-bis(3-carboxyphenyl)propane, bis(3-carboxyphenyl)methane, 2,2-bis(3-carboxyphenyl)hexafluoropropane, 2,2-bis(3-carboxyphenyl)ketone, bis(3-carboxyphenoxy)benzene, naphthalene dicarboxylic acids, including 2,6-naphthalene dicarboxylic acid, 2,7-naphthalene dicarboxylic acid, 1,4-naphthalene dicarboxylic acid, 2,3-naphthalene dicarboxylic acid, 1,8-naphthalene dicarboxylic acid and biphenyl-4,4′-dicarboxylic acid, and
an aliphatic dicarboxylic acid comprising two reactive carboxylic acid groups [acid (AL)], which is selected from the group consisting of oxalic acid (HOOC—COOH), malonic acid (HOOC—CH₂—COOH), succinic acid [HOOC—(CH₂)₂—COOH], glutaric acid [HOOC—(CH₂)₃—COOH], 2,2-dimethyl-glutaric acid [HOOC—C(CH₃)₂—(CH₂)₂—COOH], adipic acid [HOOC—(CH₂)₄—COOH], 2,4,4-trimethyl-adipic acid [HOOC—CH(CH₃)—CH₂—C(CH₃)₂— CH₂—COOH], pimelic acid [HOOC—(CH₂)₅—COOH], suberic acid [HOOC—(CH₂)₆—COOH], azelaic acid [HOOC—(CH₂)₇—COOH], sebacic acid [HOOC—(CH₂)₈—COOH], undecanedioic acid [HOOC—(CH₂)₉—COOH], dodecandioic acid [HOOC—(CH₂)₁₀—COOH], tridecanedioic acid [HOOC—(CH₂)₁₁—COOH], tetradecandioic acid [HOOC—(CH₂)₁₂—COOH], octadecandioic acid [HOOC—(CH₂)₁₆—COOH], and cycloaliphatic-group containing acids, in particular 1,4-cyclohexane dicarboxylic acid, 1,3-cyclohexane dicarboxylic acids, as cis or trans diastereoisomers, possibly in admixture;
and/or
wherein the amine (NN) is selected from the group consisting of aliphatic diamines (NNa), aromatic diamines (NNar) and mixtures thereof, wherein:
said aliphatic diamines (NNa) may be or include aliphatic alkylene diamines (NNaa), having 2 to 18 carbon atoms and/or maybe or include a cycloaliphatic diamine, i.e. a diamine comprising a cycloaliphatic group having 2 to 18 carbon atoms [amine (NNca)].

7. The assembly (MP) of claim 6, wherein the polyamide (PA) is selected from the group consisting of:
(A1) semi-aromatic polyamides comprising, units which are the condensation product of mixtures comprising:
the at least an aromatic diacid, and derivatives thereof, possibly in combination with the aliphatic dicarboxylic acid and derivatives thereof; and
the at least an aliphatic diamine [amine (NNa)] and derivatives thereof;
(A2) semi-aromatic polyamides comprising, recurring units which are the condensation products of mixtures comprising:
the at least one aliphatic diacid and derivatives thereof, and
the at least one aromatic diamine, and derivatives thereof,
and wherein:
(1) the polyamide (PA) of type (A1) is preferably selected from the group consisting of:
polyamides comprising, units which are the condensation product of mixtures of 1,6-diaminohexane and terephthalic acid, possibly in combination with isophthalic acid, that is to say resulting polycondensation product being a polyamide 6T or a polyamide 6T/6I;
(ii) polyamides comprising, units which are the condensation product of mixtures of 1,6-diaminohexane, 1,10-decamethylenediamine, and, possibly, 1,3-bis-(aminomethyl)-cyclohexane, and terephthalic acid, that is to say resulting polycondensation product being a polyamide 6T/10T or a polyamide 6T/10T/BACT
(iii) polyamides comprising, units which are the condensation product of mixtures of 1,6-diaminohexane, adipic acid and terephthalic acid, possibly in combination with isophthalic acid, that is to say resulting polycondensation product being a polyamide 6T/66 or a polyamide 6T/6I/66;
(iv) polyamides comprising, units which are the condensation product of mixtures of 1,6-diaminohexane, 1,3-bis-(aminomethyl)-cyclohexane (BAC), 1,4-cyclohexanedicarboxylic acid (cis, trans or cis/trans mixtures) (CHDA), terephthalic acid, and that is to say resulting polycondensation product being a polyamide 6T/BACT/6CHDA/BACCHDA, and
(2) the polyamide of type (A2) is a polyamide comprising, units which are the condensation product of mixtures of m-xylenediamine (MXDA) and adipic acid, that is to say resulting polycondensation product being a polyamide MXD6.

8. The assembly (MP) of claim 1, wherein the polymer composition (C) is a poly(arylene sulphide)-based composition wherein the polymer (PAS) is present in a total amount of greater than 30 wt. %, based on the total weight of the polymer composition (C), and/or the polymer (PAS) is present in a total amount of less than 95 wt. %, based on the total weight of the polymer composition (C).

9. The assembly (MP) of claim 8, wherein the polymer (PAS) comprises recurring units (R_{PAS1}) represented by the following formula: 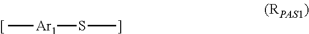
wherein
—Ar₁— is selected from the group of formulae consisting of: 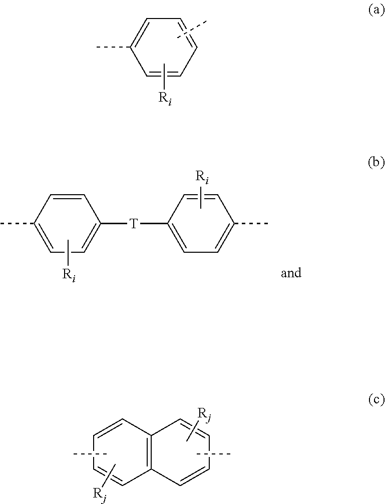
wherein:
R, at each instance, is independently selected from the group consisting of a C₁-C₁₂ alkyl group, a C₇-C₂₄ alkylaryl group, a C₇-C₂₄ aralkyl group, a C₆-C₂₄ arylene group, and a C₆-C₁₈ aryloxy group;
T is selected from the group consisting of a bond, —CO—, —SO₂—, —O—, —C(CH₃)₂—, —C(CF₃)₂—, phenyl and —CH₂—;
i, at each instance, is an independently selected integer from 0 to 4;
j, at each instance, is an independently selected integer from 0 to 3.

10. The assembly (MP) of claim 9, wherein the polymer (PAS) is a polymer (PPS) having units (R_{PAS1}) of formula: 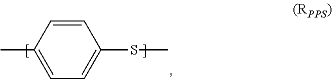
and which optionally comprise units of any of formulae: 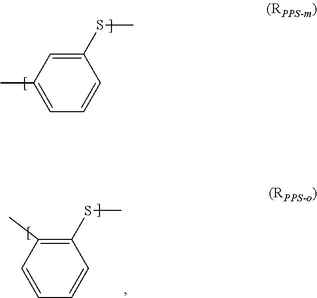
with the further condition that when polymer (PPS) further comprises units (R_{PPS-m}) and/or (R_{PPS-o}), the total concentration of recurring units (R_{PSS-m}) and/or (R_{PSS-o}) in the polymer (PPS) is at most 10 mol %, based on total amount of units (R_{PPS}), (R_{PPS-m}) and (R_{PPS-o}).

11. The assembly (MP) of claim 1, wherein the flat glass fibers have a non-circular cross section selected from an elliptical section, oblong-circular section, rectangle section, a section in which half rounds are connected to both short sides of a rectangle, and cocoon section; and/or wherein the flat glass fibers have an aspect ratio, being the ratio between the cross-sectional longest dimension and the cross-sectional shortest dimensions, of from 1.0 to 10.

12. The assembly (MP) of claim 1, wherein the metal insert of the assembly (MP) comprise areas of its surface not covered by the plastic component.

13. A method of making the assembly (MP) of claim 1, said method comprising assembling the metal insert and the plastic component.

14. The method of claim 13, wherein the method comprises:
Step 1—a step of placing a pre-molded metal insert is placed into a mold; and
Step 2—a step of molding the polymer composition (C) in said mold comprising the pre-molded metal insert.

15. A method comprising incorporating the assembly (MP) of claim 1 in an automotive component for automotive applications.

16. The method of claim 15, wherein the automotive application is an e-mobility application.

17. The assembly (MP) of claim 9, wherein Ar₁— is represented by any of the following formulae:

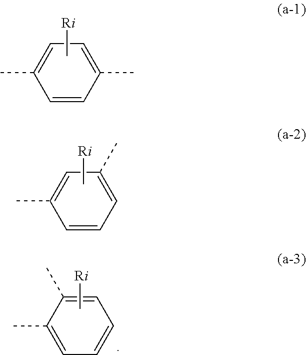

18. The assembly (MP) of claim 17, wherein Ar₁— is represented by any of formulae (a-1), (a-2) and (a-3), and where i is zero.
